(19) United States
(12) Patent Application Publication
(10) Pub. No.: US 2010/0162289 A1
(43) Pub. Date: Jun. 24, 2010

(54) METHOD AND APPARATUS FOR PROVIDING SUBSCRIBER INCENTIVES TO VIEW ADVERTISING THAT ACCOMPANIES PROGRAMMING CONTENT DELIVERED OVER A CONTENT DELIVERY SYSTEM

(75) Inventor: John Sanders, Ramona, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/341,405

(22) Filed: Dec. 22, 2008

(51) Int. Cl. H04N 7/16

(52) U.S. Cl. 725/23

(57) ABSTRACT

A method is provided for incentivizing a viewer to view advertisements presented during programming delivered over a content delivery system. The method includes receiving over a content delivery system a program and one or more advertisements associated therewith. At least a portion of the program and at least one of the advertisements associated therewith is rendered. A first video segment is received over the content delivery system. The first video segment prompts the viewer to provide user input indicating that the viewer has viewed at least one of the advertisements. The prompt is presented to the viewer. The user input is received in response to presentation of the prompt. The viewer is rewarded after at least one predetermined criterion is met. The predetermined criterion includes a determination that the user input is a proper response to the prompt.

### FIELD OF THE INVENTION

The present invention relates generally to content delivery systems for distributing programming content to viewers over a system such as a satellite or cable television system, and more particularly to a content delivery system in which viewers are provided with an incentive to view advertising that accompanies the programming content.

### BACKGROUND OF THE INVENTION

As is well known, advertising forms an important part of programming that is broadcast or otherwise delivered to viewers. The revenues generated from advertisers subsidize and in some cases pay entirely for the programming. Even in subscriber-based television systems such as cable and satellite television systems, the revenues from advertisements subsidize the cost of the programming, and were it not for advertisements, the monthly subscription rates in such systems could be many times higher than at present.

Despite the efforts that are used to make advertisements appealing, viewers will often still avoid viewing television advertisements. Television advertisements may be avoided in a number of ways including, for example, by switching television channels during an advertisement or by recording a television program and then using trick mode functionality to skip recorded advertisements. Advertisement avoidance results in lower advertisement exposure for advertisers and, therefore, in lower potential revenue for television service providers. Therefore, there is a need for systems and methods for increasing the viewing of television advertisements.

### SUMMARY OF THE INVENTION

In accordance with the present invention, a method is provided for incentivizing a viewer to view advertisements presented during programming delivered over a content delivery system. The method includes receiving over a content delivery system a program and one or more advertisements associated therewith. At least a portion of the program and at least one of the advertisements associated therewith is rendered. A first video segment is received over the content delivery system. The first video segment prompts the viewer to provide user input indicating that the viewer has viewed at least one of the advertisements. The prompt is presented to the viewer. The user input is received in response to presentation of the prompt. The viewer is rewarded after at least one predetermined criterion is met. The predetermined criterion includes a determination that the user input is a proper response to the prompt.

In accordance with another aspect of the invention, a set top terminal is provided which includes a receiver/tuner for receiving programming and advertising over a content delivery system. The set top terminal also includes a user interface for receiving user inputs and an advertisement management module for receiving a message over the content delivery system. The message includes a prompt that causes a user to provide user input, via the user interface, indicating that the user has viewed at least one advertisement received over the content delivery system. The advertisement management module also causes the prompt to be rendered on a display device, and further causes rewards currency to be allocated to the user if the user input is a proper response to the prompt. A processor is operationally associated with the receiver/tuner, the user interface and the advertisement management module.

### BRIEF DESCRIPTION OF THE DRAWINGS

FIG. 1 is one example of a system architecture for delivering programming content to end user terminals such as set top terminals.

FIG. 2 shows one example of a headend.

FIG. 3 shows one example of a set top terminal.

FIG. 4 shows one example of a method of incentivizing a viewer to view advertisements presented during programming delivered over a content delivery system.

### DETAILED DESCRIPTION

As detailed below, a viewer may be provided with an incentive to view advertisements (“ads”) that accompany other programming. This may accomplished, in one implementation, by providing rewards to viewers after the viewer's set top terminal or other client device receives and identifies an ad and presents an interactive event that elicits a response from the viewer. The interactive event, which may be context dependent, may be any event designed to indicate that viewers have actually viewed ads that have recently been presented. Examples of such interactive events will be presented below. As used herein, advertisements refer to any content that interrupts the primary content that is of interest to the viewer. Accordingly, advertising can include but is not limited to, content supplied by a sponsor, the service provider, or any other party, which is intended to inform the viewer about a product or service. For instance, public service announcements, station identifiers and the like are also referred to as advertising. Various examples of an advertising incentive program will be presented below.

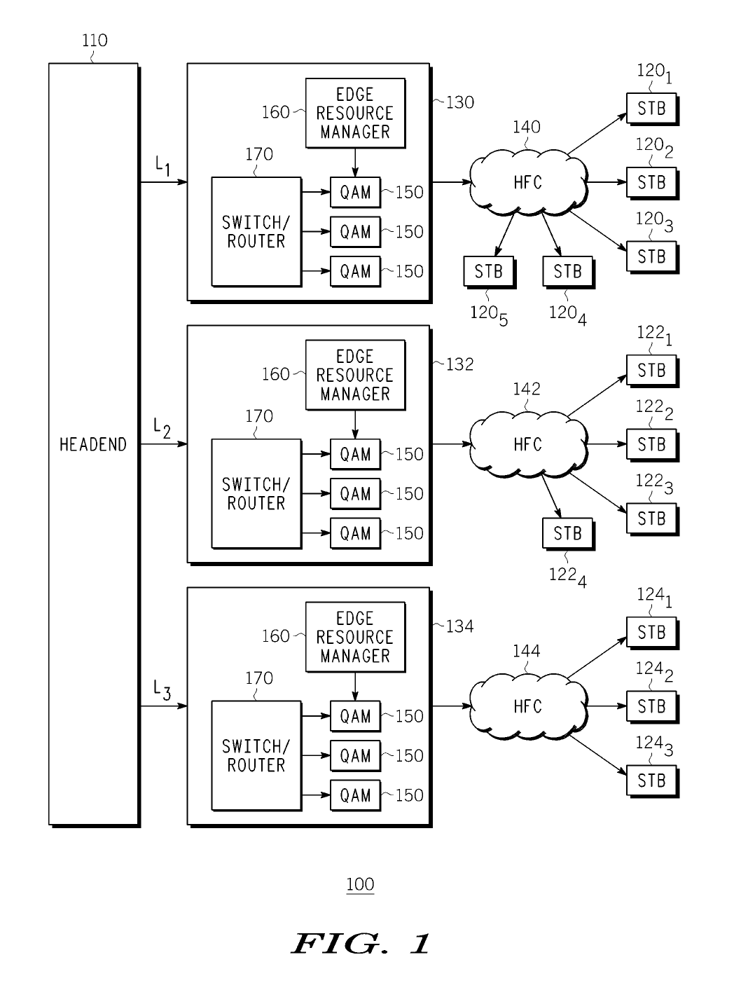

FIG. 1 is one example of a system architecture 100 for delivering programming content to end user terminals such as set top terminals. Among other components, system architecture 100 comprises a content source such as a headend 110 that delivers the content to the end users over a content delivery system that in this example includes multiple intermediate entities such as hubs 130, 132 and 134. In particular, the headend 110 communicates with a switch or router 170 in hubs 130, 132 and 134 over links L1, L2 and L3, respectively. The headend 110 and hubs 130, 132 and 134 may communicate over a packet-switched network such as a cable data network, passive optical network (PON) or the like using, for example, IP multicast or unicast addressing.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices, which for purposes of illustration will be referred to hereinafter as set top terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by a system operator that operates the network.

Each hub 130, 132 and 134 also includes an edge resource manager 160 for allocating and managing the resources of the edge devices 150. The edge resource manager 160 communicates with and receives instructions from the session manager located in the headend 110.

When a viewer selects a channel using an end user device such as a set top terminal, the system actively switches the channel onto one of the QAMs that serves that particular set top terminal. The set top terminals are generally arranged into service groups and each of the service groups is assigned to, and serviced by, one or more QAM modulators. For example, in the arrangement depicted in FIG. 1 set top terminals 120₁, 120₂, 120₃, 120₄ and 120₅ are assigned to QAM modulators 150 located at hub 130, set top terminals 122₁, 122₂, 122₃ and 122₄ are assigned to QAM modulators 150 located at hub 132, and set top terminals 124₁, 124₂ and 124₃ are assigned to QAM modulators 150 located at hub 134. Typically, four (4) or eight (8) QAM modulators are deployed per service group to carry the channels. Service groups currently include from about 500 to 1000 set top terminals. Depending on the system topology, there may or may not be a one-to-one correspondence between the hubs and the service groups. For instance, it is typically the case that each hub serves multiple service groups.

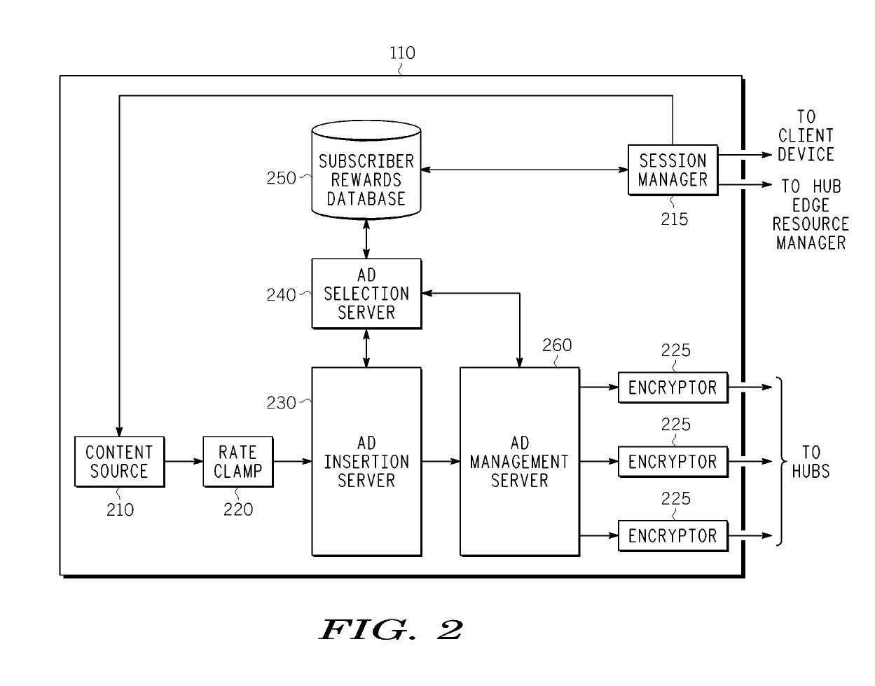

FIG. 2 shows one example of headend 110. The headend 110 includes a broadcast content source 210, which may include, by way of example, satellite receivers, off-air receivers and/or content storage devices such as servers. The headend 110 also includes a session manager 215. The session manager 215 is used to determine which transport streams are being transmitted by the headend at any time and for directing the set top terminals to the appropriate stream. The session manager 215 also keeps track of which viewers are watching which channels and it communicates with the edge resource managers 160 (see FIG. 1) in the hubs so that the content can be switched on and off under the control of the session manager 215. In addition, all viewer requests for a channel or other services go through the session manager 215. Content is forwarded by the content source to a rate clamp 220, an ad insertion server 230 that inserts the appropriate advertisements into their respective timeslots, an ad management server 260 that incorporates a user interface video segment and one or more optional encryptors 225. The ad management server 260 inserts the questionnaire or other prompts into the transport stream which are used to elicit responses from the viewers. In this example the content is then encrypted by the encryptors 225 and transmitted to the appropriate hub or hubs using, for instance, multicast addressing. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown). The ad insertion server 230 inserts advertisements under the direction of an ad selection server 240. The ad insertion server 230 may add all the ads that are to be included with the content. Alternatively, the ad insertion server 230 may insert local ads that supplement ads that are already present in the content when it is received by the content source 210. The headend 110 may also include a subscriber rewards database 250 that can be used to maintain subscriber accounts concerning the rewards that each subscriber has accumulated. Both the subscriber rewards database 250 and the ad management server 260 will be discussed in more detail below.

It should be noted that the headend 110 shown in FIG. 2 may also include a variety of other components for offering additional services. For example, the headend 110 may comprise typical headend components and services including a billing module, a video-on-demand (VOD) server, a subscriber management system (SMS) or billing module, a conditional access system and a LAN(s) for placing the various components in data communication with one another. Also, although not shown, one of ordinary skill in the art would recognize that other components and arrangements for achieving the various functionalities of headend 110 are possible. It will also be appreciated that the headend configurations depicted in FIG. 2 is a high-level, conceptual architecture and that each system may have multiple headends deployed using different architectures.

The digitally encoded content is transmitted by the headend 110 in a digital transport stream that is arranged in predetermined media format. For instance, the content is preferably arranged in accordance with an MPEG media format, such as the MPEG-2 media format, but may be arranged in accordance with other media formats, including but not limited to other MPEG formats, Hypertext Markup Language (HTML), Virtual Hypertext Markup Language (VHTML), X markup language (XML), H.261, or H.263 formats. An individual program generally composes a single program transport stream. The single program transport stream includes the various program elementary streams such as video, audio and data elementary streams. The single program transport stream also includes program specific information associated with the elementary streams such as system tables, which in the case of MPEG, for example, includes the Program Map Table (PMT). The PMT describes the elementary streams (e.g., video, audio and data streams) that compose the program being recorded. The PMT specifies the packet identifiers (PIDs) for each elementary stream. For instance, a video program will generally include a video and audio PID as well as certain other PIDs such as a Program Clock reference (PCR) PID and an Entitlement Control Message (ECM) PID. A digital transport stream may include a series of single program transport streams, each of which can be identified by the various PIDs with which they are associated.

Along with the ads, in some cases the headend 110 may also send to the set top terminals metadata that can be used to uniquely identify and characterize the advertisements. For instance, the metadata may specify the time and channel at which the ad is presented and the identity of the advertiser. The metadata can be sent either embedded in the advertisement or separate from it with the appropriate associating links. The metadata may be incorporated with the advertisements in any format that allows it to be recognized and extracted by the set top terminal. For example, the metadata may be incorporated into a program map table of an MPEG-2 bit stream or in a newly established system table. In another example, the metadata may be incorporated into the advertisement via standards established with the use of a metalanguage used to describe structured information. For example, the metalanguage that is employed may be a universal data format such as XML.

As previously mentioned, a viewer may be provided with an incentive to view advertisements that accompany other programming. The incentive can be provided if user inputs that are received by the set top terminal either confirming that the advertisement has been, is being, and/or will be viewed or that the viewer is at least present while the ad is being rendered. The user inputs, or aggregate information summarizing the results of the user inputs, may be optionally forwarded to the headend 110 and stored in subscriber rewards database 250. User input may be solicited, for instance, at the end of an ad's presentation, when the viewer may be presented with an interactive event that requires a response. For instance, the interactive event may require the viewer to “shoot” an animated figure that is displayed on the screen using cursor keys on a remote control unit. The animated figure that is used, as well as the degree of attention and activity required on the part of the viewer, may depend on the expected audience for the ad. As a concrete example, an animated insect or the like may be superimposed over the ad or program, perhaps when the anticipated audience is a child. The viewer may be required to brush away or squash the fly using the cursor keys on the remote control unit. In another example, the interactive event may require the viewer to select from among alternative conclusions to an ad or trigger a pop-up. For instance, if a story line in an ad depicts a rivalry between a man and a woman, the ad may be transmitted with multiple endings, in some of which the man triumphs and others in which the woman triumphs. The viewer can select from among the endings and the selection can be spliced in so that it can be viewed by the viewer.

In yet another alternative, the interactive event may present the viewer with a menu of one or more questions designed to elicit a response from the viewer that he or she actually viewed the preceding ad or ads. In many cases the nature of the question(s) and the answer(s) received will be less important than the mere fact that a viewer provided a response, which at least suggests that he or she was viewing the preceding ad. In other cases, the response to the questions may provide valuable information that can be used, for example, by the MSO and/or the advertiser. Such questions may elicit information rating the quality of the ads, for instance, or soliciting viewer's reward preferences. While the menu of questions may be presented to the user at any time during the programming, it will typically be presented at some point during a sequence of ads that are presented during a break in the primary programming.

It should be emphasized that the interactive event which is presented to the viewer to elicit a response is not limited to any of the examples presented above. More generally, the interactive event may be any event presented to the viewer which is designed to prompt the viewer to provide a response.

The viewer may receive rewards currency when they respond to the interactive event presented to them. In some implementations the incentive may take the form of an award of currency, e.g. a cash back rebate or reward points for providing the responses. A cash back rebate may take the form of a discount from the MSO or other service provider on the cost of their content delivery service. If reward points are earned by the viewer, they may be redeemed for discounts on the purchase of any of a variety of products and services (e.g., a pay-per-view event). In some cases rewards points may make the viewer eligible to view special events such as previews of programming before they are released to the general public. Of course, other forms of rewards currency may also be issued, such as coupons, certificates and the like. Rewards currency can be assigned each time the viewer submits a response to the interactive event. For example, one point may be assigned for every advertisement that is viewed. In other examples, rewards currency may be issued based upon the viewer meeting a set of pre-defined rules that may include, for instance, a series of responses that indicates that the viewer has viewed a predetermined number of ads over a period of time such as a day, week or month. In some cases the viewer may be able to use the rewards currency to purchase items that may be made available on menus that can be presented when the viewer's advertising preferences are obtained.

The aforementioned interactive event that is designed to ascertain a viewer's attention to one or more ads may be delivered to the set top terminal as a short segment of video in a file that is referred to herein as a Viewer Attention Check (VAC) file. The VAC file may be delivered to the set top terminal in any suitable manner. For instance, in some implementations the VAC file associated with a program and its advertisements may be delivered to the set top terminal in the same transport stream (e.g., an MPEG transport stream) that is used to deliver the program itself. This can be accomplished by inserting the VAC file into the transport stream using the ad management server 260. In this case the VAC file can be sent in its own service within the digital transport stream. In other cases, the program and the VAC file may be transmitted in separate transport streams. One disadvantage of this latter approach, however, is that the set top terminal will be required to tune to the two different streams at the same time, which is a capability that is available in some but not all set top terminals. In yet other implementations the VAC file may be sent out-of-band or in accordance with Internet protocols. The ad management server 260 may operate in cooperation with the ad selection server 240 to ensure that the interactive events designed to elicit user input are properly coordinated with the ads that are being inserted with the programming by the ad insertion server 230.

The interactive event that prompts the viewer for a response may contain additional content that is designed to appeal to viewers, thus increasing the likelihood of receiving a response to the event. For instance, the VAC file may include a humorous segment preceding and/or following the actual segment that includes the prompt. In addition, if the interactive event includes questions, the questions themselves may be designed to appeal to viewers. In one example the questions may include a topical quiz that is easy for most people to answer correctly. The questions may also relate to the preceding ad or ads that were presented to the viewer, thereby gauging the amount of attention that the viewer gave to the ad. The viewer will generally be given a relatively long amount of time to respond to the interactive event, typically longer than the duration of the content in the VAC file. It should be noted, however, that the VAC file itself may not have a finite length since it may be delivered in accordance with a carousel protocol or as an application file that does not execute in real time. The duration of the interactive event may be controlled by the metadata that is associated with the ads. In this way the MSO or the advertiser can control the length of the interactive event associated with a particular ad. A tolerance may be incorporated that allows for a specified number of timeouts and wrong responses before the viewer is deemed to have failed. If the viewer does fail, no rewards currency will be issued to the viewer. In addition, the set top terminal should be able to distinguish between legitimate or proper user responses to an interactive event and bogus responses (e.g., repeated actuation of a single key on a remote control unit). Improper or invalid responses should be rejected.

The VAC file may also include a reward opportunity segment that presents the viewer with pertinent details describing the rewards program and facilitating its effective use by the viewer. For instance, the rewards opportunity segment may specify whether a reward will be issued for viewing any advertisements or a particular set of advertisements such as those affiliated with a particular vendor. The segment may also specify how many ads must be viewed before a reward will be issued and the time period over which those ads must be viewed. Alternatively, it may be desirable for the viewer to be unaware of this information, in which case it may only be included in the metadata that is sent along with the ads. Unlike the prompts that are included in the VAC file, the reward opportunity segment will generally not require any user interaction. Accordingly, in some implementations it may be convenient to deliver the reward opportunity segment in a separate file from the remainder of the VAC file. Similar to the VAC file, the reward opportunity file may be delivered in its own service within the digital transport stream that includes the primary programming.

The rewards currency may be paid by the MSO or the advertisers themselves. In some cases the MSO may pay for currency that has been issued for overall viewing while the advertiser may pay for the viewing of a particular ad. To properly allocate charges among the various parties, the set top terminal can read the ad metadata that is delivered along with the ads. In this way the set top terminal can keep track of the overall number of ads and the identity of the ads that are presented to the viewer using the ad metadata. The set top terminal can also keep track of the subset of those ads that the viewer has viewed over a period of time such as a day, week or month. If the program has been recorded by the viewer on a DVR subsystem, the set top terminal can also ensure that rewards currency is issued only when proper (e.g., correct) responses are received and when the viewer does not fast forward through the ads with which those responses are associated.

In some implementations instead of the set top terminal, the headend may determine the amount of rewards currency that is to be allocated to the viewers. In this case the set top terminal may simply relay the number of correct responses to the headend, which can then calculate the amount of rewards currency that is to be allocated. This information can be maintained in the subscriber rewards database 250 shown in FIG. 2. In other implementations these various tasks may be shared between the headend and the set top terminals in any number of different ways. Moreover, in some of these implementations there may be some redundancy in the tasks that are respectively performed by the headend and the set top terminals. Such redundancy may be useful to ensure that rewards currency is accurately distributed.

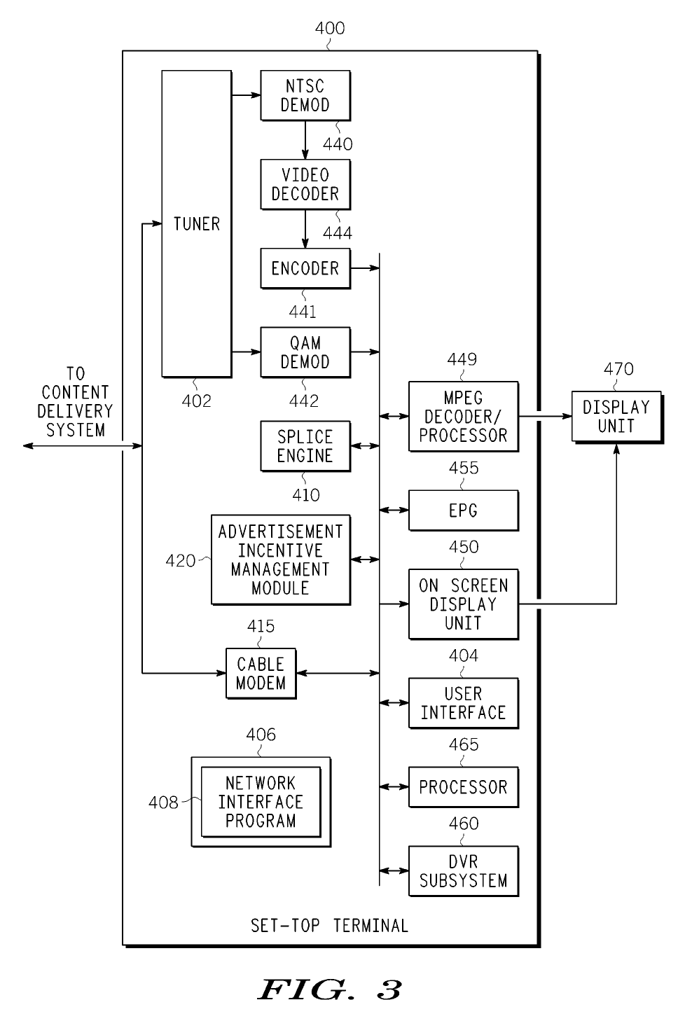

One example of a set top terminal 400 is shown in more detail in FIG. 3. It should be noted that set top terminal 400 more generally may be any apparatus such as a hardware card, specially programmed computer or other device having the functionality described herein that may be placed near to or within a television or other display device (such as a computer monitor) such as display unit 470. The set top terminal 400 receives content from the content delivery system seen in FIG. 1. Broadly speaking, a traditional set top terminal such as that depicted in FIG. 3 is a device that can receive, store and forward content without manipulating the content in any significant way except to format it so that it may be rendered in a suitable manner.

Set-top terminal 400 includes an in-band tuner 402, which tunes to a channel selected by the viewer via user interface 404. While not shown, a second in-band tuner may be provided, which could, for example, be used to receive the VAC files when they are transmitted on a separate transport stream. User interface 404 may be any control device such as a remote control, mouse, microphone, keyboard, or display. NTSC demodulator 440 and digital demodulator 442 are responsive to in-band tuner 402. NTSC demodulator 440 includes components responsive to receive analog versions of a channel signal. A digital demodulator 442, which as shown is a QAM demodulator, but, which may be any type of digital demodulator device, includes components responsive to receive digital versions of a channel signal, and to output video information. QAM demodulator 442 receives and processes digital data packets from one or more digital sources, such as a digital television signal, an MPEG transport stream, or a media stream from an external network connection, such as cable modem 415 (if available), using well-known methods and techniques. Video decoder 444 is responsive to receive and decode video information.

Video information that may require format translation or modification for compatibility with capabilities of set top terminal 400 may be passed to encoder 441 for formatting. Video information that is in a format preferred for use by MPEG Decoder/Multi Media Processor 449 may be passed directly to MPEG Decoder/Multi Media Processor 449. Encoder 441 is operative to perform predetermined coding techniques (for example, MPEG-2, MPEG-4, and others) to produce an encoded video signal for transmission to MPEG Decoder/Multi Media Processor 449, or for storage. MPEG Decoder/Multi-Media Processor 449 is operative to perform predetermined coding techniques to arrange video information into displayable formats, in accordance with well-known methods and techniques. Internal arrangements of MPEG Decoder/Multi-Media Processor 449 are well known, and may include analog-to-digital converters, one or more storage media and/or buffers, and general or special-purpose processors or application-specific integrated circuits, along with demultiplexers for demultiplexing and/or synchronizing at least two elementary transport streams (for example, video and audio).

Splice engine 410 may be employed when the advertisements are made available on a separate transport stream from the programming, for example. The splice engine 410 may also be employed if the VAC file is to be presented as an interstitial between advertisements or between an advertisement and the program. The splice engine 410 may implement any appropriate splicing process. Since the programs and commercials are typically digitally encoded data streams (e.g., MPEG-2 data streams), the set top terminal should preferably be configured to support digitally encoded data stream splicing without converting the data stream to the analog domain. In the context of MPEG-2, for instance, at the appropriate time the session manager can instruct the set top terminal to insert the particular VAC file by specifying the PID of the file. The session manager can send the PIDs in the same manner it sends other control information to the set top terminals using either in-band or out-of-band channels.

An electronic program guide (EPG) 455 is also provided in set top terminal 400. The EPG, which is generally received along with the programming content, may be updated on a periodic basis so that the consumer can make appropriate selection for upcoming programs. In some cases, instead of transmitting it along with the programming, the electronic program guide 455 may be downloaded via a telephone line, cable connection, satellite up-link, down-link, or radio broadcast antenna.

The set top terminal 400 also includes an advertisement incentive management module (e.g. an application) 420 for implementing the advertising incentive program. The advertisement incentive management module 420 may include an interactive, on-screen display feature that acquires the VAC and other files associated with the advertising incentive program and presents them to the viewer in an appropriate manner. For instance, the VAC file may include prompts, which the advertisement incentive management module 420 presents to the viewer. As previously mentioned, the advertisement management module 420 may receive the prompts and other necessary information in the form of files, software objects and the like from the headend 110. Updates may be provided to the advertisement management module 420 in this manner as well. The advertisement incentive management module 420 also receives the user responses to the prompts, which are received via the user interface 404. For instance, the prompts may be multiple choice questions that require the user to make a selection that is entered through a remote control unit. Correct responses to the questions are tallied by the advertisement incentive management module 420, which can also allocate rewards currency as appropriate in coordination with the metadata associated with the ads. As previously mentioned, in some implementations the advertisement incentive management module 420 may simply relay the proper responses to the headend 110, which can tally them and allocate rewards currency. In this case the advertisement management module 420 may serve as a repository such as a buffer for the viewer's responses until they are forwarded to the headend 110.

An on-screen display unit 450 is provided in set top terminal 400. The on-screen display unit 450 is used to display information such as control menus and the like as well as information received from the service provider that needs to be directly presented to the user regardless of the particular programming or channel that the user is currently viewing. In particular, on-screen display unit 450 displays the information provided by the advertisement incentive management module 420. Accordingly, on-screen display unit 450 can forward the interactive event and the like directly to the display unit 470. Alternatively, the interactive event or prompt may appear as an overlay, pop up, or scrolling text ticker that is superimposed on the current programming being viewed, possibly using a blending or overlay circuit that may be associated with the on-screen display unit 450.

DVR subsystem 460 is provided for recording programs received from the access network. DVR subsystem 460 can control the channel tuned by tuner 402 and record programming on a manual or timer control basis. Additionally, the DVR subsystem 460 can buffer incoming programs to enable a view to pause or replay a portion of a live program.

Set-top terminal 400 further includes a computer-readable storage medium 406. Computer-readable storage medium 406 may be any local or remote device capable of recording or storing data, and in particular may be, or may include, a read only memory (“ROM”), flash memory, random access memory, a hard disk drive, all types of compact disks and digital videodisks, and/or magnetic tape. Various application programs may reside on storage medium 406, possibly including the advertisement incentive management module 420. The applications residing on storage medium 406 may be computer programs that include software components implemented according to well-known software engineering practices for component-based software development and stored in computer-readable memories, such as storage medium 406. The applications, however, may be any signal processing methods and/or stored instructions, in one or more parts, that electronically control functions set forth herein. Storage medium 406 may also include other programs to provide additional functionality. For example, a network interface program 408 may be provided that represents aspects of the functional arrangement of various computer programs that pertain to the receipt and processing of content and other data over a content delivery system.

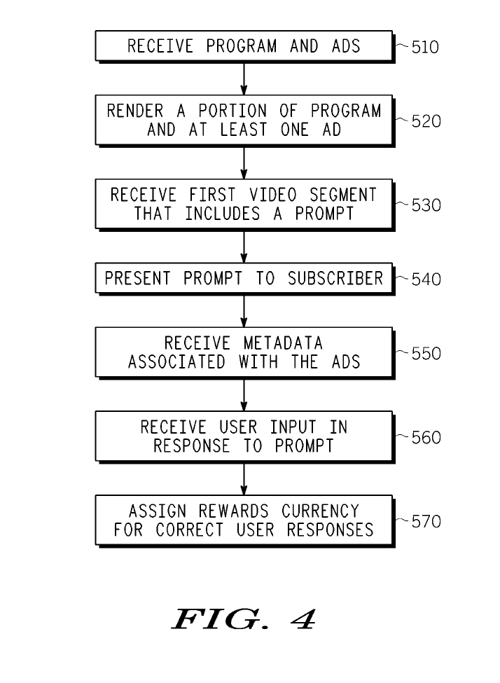

The various components of set top terminal 400 discussed above may all operate under the overall control of a processor 465. Moreover, it is contemplated that the processor 465, tuner 402, video decoder 449, user interface 404, onscreen display unit 450, splice engine 410, advertisement incentive management module 420 and the other components shown in FIG. 4 may each be implemented in hardware, software or a combination thereof In addition, although the various components are shown as separate processors, it is contemplated that they may be combined and implemented as separate processes on one or more processors.

FIG. 4 shows one example of a method of incentivizing a viewer to view advertisements presented during programming delivered over a content delivery system. The method begins in step 510 when an end user device such as a set top terminal receives a program and one or more advertisements associated therewith over the content delivery system. At least a portion of the program and one of the advertisements are rendered by the set top terminal on a display device in step 520. The set top terminal also receives a first video segment over the content delivery system in step 530. The first video segment prompts the viewer to provide user input indicating that the viewer has viewed at least one of the advertisements. In one example the prompt is a questionnaire that is presented to the viewer on the display device. The prompt is presented to the viewer in step 540. If the prompt is a questionnaire, the questionnaire may be rendered on the viewer's display device. The set top terminal also receives over the content delivery system in step 550 metadata that is associated with one or more of the advertisements. Among other things, the metadata specifies a source (e.g. advertiser) of the advertisements and a time at which the advertisements are presented to the viewer. The set top terminal receives, in step 560, user input in response to presentation of the prompt. The user input may be answers to the questions in the questionnaire. If the viewer provides an appropriate or otherwise proper response to the prompt, rewards currency is assigned to the viewer in step 570. In those cases where the prompt includes a question, a proper response may or may not be a correct answer to the question. That is, even an incorrect answer may be sufficient to indicate that the viewer has viewed the advertisement(s). This process repeats for subsequent video segments and programs until the viewer accumulates a sufficient amount of rewards currency to receive a reward, at which time the rewards currency may be redeemed for a rewards. In some cases the viewer may be able choose from among a variety of different rewards.

The processes described above, including but not limited to those shown in FIG. 4, may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized.

It will furthermore be apparent that other and further forms of the invention, and embodiments other than the specific embodiments described above, may be devised without departing from the spirit and scope of the appended claims and their equivalents, and it is therefore intended that the scope of this invention will only be governed by the following claims and their equivalents.

A method and apparatus have been described for providing subscribers or other viewers an incentive to view advertisements by providing them with a reward if they view the ads, as verified by an interactive event that elicits a response from the viewer. The interactive event may be any event presented to the viewer by the set top terminal that causes the viewer to provide a response through the set top terminal's user interface.

1. A method of incentivizing a viewer to view advertisements presented during programming delivered over a content delivery system, comprising:
receiving over a content delivery system a program and one or more advertisements associated therewith;
rendering at least a portion of the program and at least one of the advertisements associated therewith;
receiving a first video segment over the content delivery system, the first video segment prompting the viewer to provide user input indicating that the viewer has viewed at least one of the advertisements;
presenting the prompt to the viewer;
receiving the user input in response to presentation of the prompt; and
rewarding the viewer after at least one predetermined criterion is met, the predetermined criterion including a determination that the user input is a proper response to the prompt.

2. The method of claim 1 wherein the prompt includes a questionnaire to be presented to the user and wherein the user input includes a response to at least one question in the questionnaire, and wherein the proper response to the prompt is a correct response to the question.

3. The method of claim 2 wherein the prompt is selected based in part on an intended audience for at least one of advertisements.

4. The method of claim 1 wherein rewarding the viewer includes assigning rewards currency to the viewer for proper responses

5. The method of claim 1 further comprising rewarding the viewer only after receiving user input in response to a plurality of prompts that indicate that the viewer has viewed a threshold number of advertisements.

6. The method of claim 5 wherein the threshold number of advertisements include advertisements viewed within a specified time period over any number of programs that are received and rendered.

7. The method of claim 1 further comprising receiving over the content delivery system metadata associated with the one or more advertisements.

8. The method of claim 7 further comprising using the metadata to determine a total number of advertisements that have been rendered over a given time period and only rewarding the viewer after receiving user input in response to a plurality of prompts that indicate that the viewer has viewed a selected subset of the total number of advertisements.

9. The method of claim 8 wherein the selected subset is a predetermined fraction of the total number of advertisements that have been rendered.

10. The method of claim 7 wherein the metadata uniquely identifies each of the advertisements and specifies a source of each of the advertisements and further comprising allocating a cost of the reward among the sources of those advertisements that are determined to have been viewed by the viewer by receipt of a proper response.

11. The method of claim 10 wherein the metadata further specifies a time at which each of the advertisements are presented to the end user.

12. The method of claim 1 further comprising storing the program and the one or more advertisements in a storage medium and rendering the program and the one or more advertisements from the storage medium.

13. The method of claim 12 wherein the at least one predetermined criterion further includes determining that the one or more advertisements with which a proper response is associated were rendered at normal speed.

14. The method of claim 1 further comprising:
receiving a second video segment describing a rewards program to incentivize viewing of advertisements; and
presenting the second video segment to the viewer prior to presenting the prompt.

15. The method of claim 14 wherein the first and second video segments are included in a common video segment.

16. The method of claim 1 wherein the program, the one or more advertisements and the first video segment are received in a common digital transport stream.

17. A set top terminal comprising:
a receiver/tuner for receiving programming and advertising over a content delivery system;
a user interface for receiving user inputs;
an advertisement management module for:
receiving a message over the content delivery system that includes a prompt that causes a user to provide user input, via the user interface, indicating that the user has viewed at least one advertisement received over the content delivery system;
causing the prompt to be rendered on a display device; and
causing rewards currency to be allocated to the user if the user input is a proper response to the prompt; and
a processor operationally associated with the receiver/tuner, the user interface and the advertisement management module.

18. The set top terminal of claim 17 wherein the advertising management module, in order to cause the rewards currency to be allocated, is configured to forward to a headend over the content delivery system a second message indicating a number of proper responses that have been received through the user interface.

19. The set top terminal of claim 17 wherein the advertising management module is configured to receive metadata associated with the at least one advertisement and to determine a total number of advertisements that have been rendered over a given time period and to only reward the user after receiving user input in response to a plurality of prompts that indicate that the user has viewed a selected subset of the total number of advertisements.

20. At least one computer-readable medium encoded with instructions which, when executed by a processor, performs a method including:
transmitting a program and one or more advertisements associated therewith to an end user device over the content delivery system;
transmitting a user-interactive video segment to the end user device over the content delivery system, the user-interactive video segment including an interactive presentation that prompts an end user to provide user input indicating that the end user has viewed at least one of the advertisements.

21. The computer-readable medium of claim 20 further comprising:
receiving from the end user device over the content delivery system a message indicating a number of responses to the questionnaire that have been provided by the end user; and
based on the number of responses, allocating a selected amount of rewards currency to the end user.

22. The computer-readable medium of claim 20 further comprising transmitting to the end user device over the content delivery system metadata associated with the one or more advertisements, the metadata specifying a time at which each of the advertisements are presented to the end user and a source of each of the advertisements.
